(19) United States
(12) Patent Application Publication
(10) Pub. No.: US 2017/0037666 A1
(43) Pub. Date: Feb. 9, 2017

(54) STALL INTRUDER DEVICE

(71) Applicant: Jerome T. Gardiner, Walker, LA (US)

(72) Inventor: Jerome T. Gardiner, Walker, LA (US)

(21) Appl. No.: 14/819,683

(22) Filed: Aug. 6, 2015

(51) Int. Cl. E05C 17/54

(52) U.S. Cl. CPC E05C 17/54

(57) ABSTRACT

A credit card size device that attaches temporarily to a hinged door in order to prevent the door from opening to ensure privacy in instances where the existing latch may be broken or missing. A front unit and a back unit are connected by an elastic member so that, when in place, tension from the elastic member causes the units to be held against the door to be secured.

### FIELD OF THE INVENTION

This invention is a small device that allows one to secure a hinged door when, for example, there is a need to secure a door that has a broken or missing lock. The device is sized to that it can be carried in the average wallet.

### BACKGROUND OF THE INVENTION

Some hinged doors, for example, doors on bathroom stalls, are normally open, but may be closed and locked or latched to allow an occupant to have privacy. In some cases, there is no lock or latch, and the hinged door remains open or partially open.

There have been several devices created as substitute or auxiliary door locks or latches that are attached to the hinge to preserve privacy and unwanted intrusions. However, such devices typically are not portable and are not applicable for many doors.

Another approach to securing hinged doors with missing or broken locks is to wedge a device that inhibits the swing, or requires the door to be modified for the device to work.

Many of the devices that claim to be temporary latch devices are bulky and difficult to carry.

There are several portable devices that are jammed into the space between the door frame and the hinged-side of the door. Some devices must be attached to a door using holes in the door. For example, see Lippman, U.S. Pat. No. 3,596,961, Boyd, U.S. Pat. No. 4,589,692, and Piva, U.S. Pat. No. 5,280,977.

Hull et al. in U.S. Pat. No. 5,415,444 discloses the use of a knob to secure hinged door without a latch.

In U.S. Pat. No. 4,326,394, Stein discloses a Z-shaped bar device that is designed to secure a door from the outside.

U.S. Pat. No. 1,607,789 by Baker and U.S. Pat. No. 5,542,723 by Scharf disclosed temporary locking devices for hinged doors that do not have a jamb. These two devices include multiple parts, and they are complex in to uses.

None of the existing devices found was light, portable, and easy to use.

### BRIEF SUMMARY OF INVENTION

The invention, the Stall Intruder Device (sometimes referred to hereinafter as “SID”), disclosed herein, is a temporary latching device that can be carried in a wallet or purse like a credit card. A SID allows one to secure a hinged door without relying on cooperation of a jamb or holes for the door to be secured.

The Stall Intruder Device is inserted into the gap between a door edge, distal to the door's hinge, and a door frame, adjacent to non-hinge edge of the door. When the door to be secured is closed the SID is rotated approximately 90° with a front unit on the outside of the door and a back unit on the inside of the door. The front unit and the back unit are connected by an elastic member attached to both the front unit and the back unit and extends between the front and back units through the gap between the door frame and the edge of the hinged door.

The front unit of the Stall Intruder Device may display label stating the stall is in use or occupied.

### BRIEF DESCRIPTION OF DRAWINGS

FIG. 1 depicts a three dimensional expanded view of a Stall Intruder Device.

FIG. 2 depicts a side view of a Stall Intruder Device in place to secure a door, showing cutaway door and jamb segments.

FIG. 3 depicts a top view of a Stall Intruder Device in place to secure a door to a doorjamb.

### DETAILED DESCRIPTION OF THE INVENTION

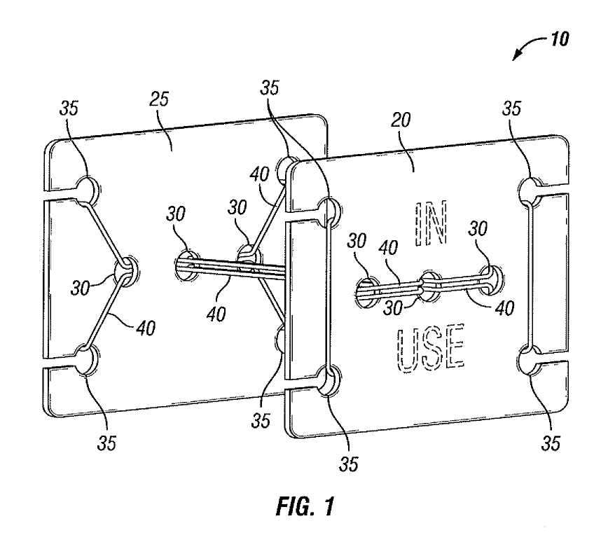

FIG. 1 shows the Stall Intruder Device (10) in an exploded view. The Stall Intruder Device (10) comprises a front unit [20] and a back unit (25), and an elastic member (40) secured to the front unit (20) and the back unit (25) through a series of center holes (30) and slots (35).

The front unit (20) and the back unit (25) are approximately the size of a typical credit card, or between about 8.0 and 9.0 mm in length and between about 5.0 and 6.0 mm in width, and more preferably 8.5 mm in length and 5.5 mm in width. The thickness of the front and back units is between 0.5 mm and 1.5 mm, and more preferably 1.0 mm.

The front unit (20) and the back unit (25) are constructed of a stiff material selected from a group consisting of light metals, hard plastics, stiff paper, hard rubber and stiff fabric.

The elastic member (40) may be constructed from any material that will deform when tension is applied, and tends to return to its original configuration when no tension is applied to it. The elastomer may be selected from a group consisting of natural rubber, isoprene rubber, neoprene rubber, nitrile rubber, silicone rubber, other polymers, and other copolymers.

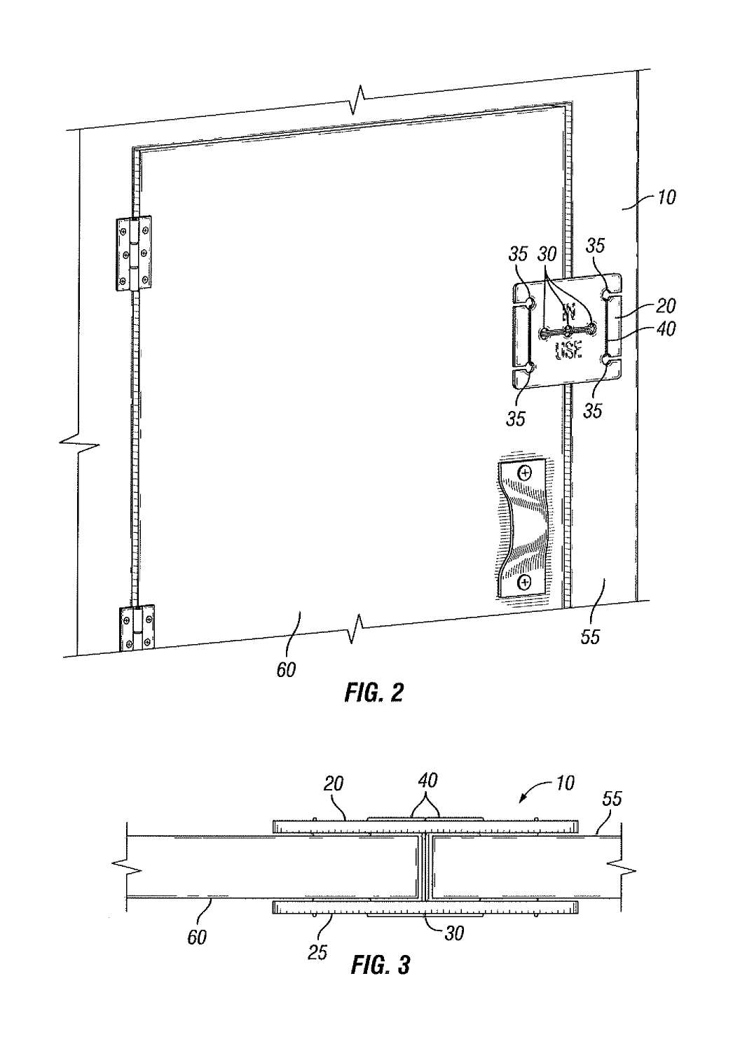

FIG. 2 depicts the Stall Intruder Device (10) viewed securing a hinged door (60) to a door jamb (55) when viewed from outside of a stall. The front unit (20) of the Stall Intruder Device (10) is held securely against a hinged door (60) and a door jamb (55) by an elastic member (40) connected through a gap between the door and the door jamb to the back unit (not shown in this Figure). The elastic member (40) is secured to the front unit (20) through a series of holes (30) and slots (35).

FIG. 3 depicts the Stall Intruder Device from the top of the door. When the Stall Intruder Device is in place to secure a stall door, the elastomer (40) has sufficient tension to hold the front unit (20) against the outside of a stall door and adjacent door frame, and the back unit (25) against the inside of a stall door and the adjacent door frame as shown in FIG. 3.

The elastomer (40) is designed to have sufficient tension to hold the front unit (20) flush against the back unit (25) when not employed to secure a hinged door.

The front unit (20) and the back unit (25) are attached by elastic means, as shown in FIG. 1, through the holes (30) and slots (35), as shown in FIGS. 2 and 3. A pressure tension arrangement is created by placing the front unit (20) on one side of a door (60) and the back unit (25) on the other side of the door.

### EXAMPLE 1

One embodiment used engineering grade plastic for construction of the front (20) unit and the back (25) unit. For this embodiment, the front (20) and back (25) units were 8.5 mm in length, 5.5 mm in width, and 1.0 mm thick.

The elastic member (40) used in this embodiment of the SID was a rubber band constructed of engineered grade synthetic rubber material, size #64.

The tension required for the elastomer was designed to create a sufficient force to cause the front unit (20) to be pressed against the outside of the door (60) and adjacent door jamb (55), and to keep the back unit (25) to be pressed against the inside of the door (60) and adjacent door jamb (55). The tension may be adjusted by altering the thickness of the elastic member (40) or arranging of the elastic member (40) in a different configuration through the holes (30), and slots (35) by one skilled in the art.

In this embodiment the tension was created by stretching a rubber band over the holes (30) and slots (35) that created a means of restriction that enable the SID to clamp to a door as shown in FIGS. 2 and 3, thereby creating enough friction to hold the SID in place and thereby discouraging the stall door from being opened from the outside. All holes were approximately 8 mm in diameter with outside holes located approximately 3 cm from the outer edges of the front unit (20) and the back unit (25) and along center line of the front unit (20) and the back unit (25). The center holes were located approximately in the center of the front unit (20) and the back unit (25). The slots were 2 mm in diameter and located approximately 1.3 cm from the closest two edges.

The front unit and the back unit, when in place, create a mechanism that is stretched across a door in order to clamp on to the door once the front and back units are released, and the tension from the elastic member dominates the forces, thereby creating a clamping effect.

1. A device that can temporarily secure a closed door against an adjacent door jamb comprising;
a) two flat units, comprising a front unit and a back unit, wherein the units are generally rectangular in shape with means of elastically attaching the front unit to the back unit when the units are positioned on the inside and outside of a door and corresponding door jamb; and
b) an elastic member elastically attaching the two flat units.

2. A device according to claim 1 wherein said units contain a series of round holes and rectilinear slots located on the flat units in an alignment that provides a means for the elastic member to attach the two flat units together.

3. A device according to claim 1 wherein the flat plates are placed under tension from the attached elastic member so that the flat units are held tightly against the outside of a door and corresponding door jamb, and the inside of the same door and corresponding door jamb.
